(19) United States
(12) Patent Application Publication
(10) Pub. No.: US 2016/0201197 A1
(43) Pub. Date: Jul. 14, 2016

(54) PROCESSES FOR FORMING METAL OXIDE FILMS ON SUBSTRATES USING AMINO ACIDS

(71) Applicant: Battelle Memorial Institute, Columbus, OH (US)

(72) Inventors: Bruce F. MONZYK, Jerome Township, OH (US); Derik R. HEISS, Plain City, OH (US)

(21) Appl. No.: 14/913,726

(22) PCT Filed: Oct. 2, 2014
(86) PCT No.: PCT/US2014/058757

§ 371 Date: Feb. 23, 2016

Related U.S. Application Data
(60) Provisional application No. 61/885,854, filed on Oct. 2, 2013.

(51) Int. Cl. C23C 18/12; B01J 21/06; B01J 37/02; B01J 35/00

(52) U.S. Cl. CPC C23C 18/1254; C23C 18/1216; C23C 18/1225; B01J 35/004; B01J 21/063; B01J 37/0219

(57) ABSTRACT

Processes for forming metal oxide films on substrates are disclosed. The processes include depositing a composition comprising a metal oxide precursor, an amino acid, and a solvent onto a substrate. The composition is dried to remove solvent, and then heated to initiate combustion to form a metal oxide film.

### CROSS-REFERENCE TO RELATED APPLICATIONS

This application claims priority to U.S. Provisional Patent Application Ser. No. 61/885,854, filed Oct. 2, 2013, the entirety of which is incorporated by reference.

### STATEMENT REGARDING FEDERALLY SPONSORED RESEARCH OR DEVELOPMENT

This invention was made with government support under Contract No. 7R01HL086652-03 awarded by the National Institutes of Health. The United States government has certain rights in the invention.

### BACKGROUND

The present disclosure is directed to processes for forming an adherent and continuous metal oxide film on a substrate. These processes have application in producing photolytic cells which may be used in the medical arts as well as other related applications requiring gas exchange between two different mediums.

Metal oxides are common components in many electronic devices, including photolytic cells. Known processes for forming metal oxide films on substrates have drawbacks. In particular, some known processes require the use of vacuum techniques which do not permit efficient large-scale production. Other processes lead to films with imperfections such as cracks, delamination, and pinholes. These deficiencies may inhibit the performance of the metal oxide film, and thus impair the performance of devices incorporating the films, including reversing the photochemistry they are designed to perform.

It would be desirable to develop a new technology for the efficient large scale production of devices comprising metal oxide films wherein the devices contain minimal cracks and pinholes.

### BRIEF DESCRIPTION

Disclosed in various embodiments herein are processes for forming uniform, adherent metal oxide films on substrates. The processes comprise providing a metal oxide precursor solution composition of matter, depositing the metal oxide precursor solution on a clean and dry substrate to form a wet coating, drying the coating to form a gel film, and heating the gel film to initiate a thermal chemical reaction to form a metal oxide film on the substrate and vented exhaust gas. The metal oxide precursor solution comprises specific molar ratios of a metal precursor, an amino acid reducing agent, an oxidant, and a solvent. Generally speaking, the metal precursor converts to a solid oxide film, and the other components are converted to gas, then removed.

Disclosed in embodiments is a process for producing a metal oxide film on a substrate, the process comprising: providing a metal oxide precursor composition comprising a metal oxide precursor, an amino acid, and a solvent; depositing the metal oxide precursor composition on a clean and dry substrate to form a wet coating, drying the coating to form a gel film, and heating the gel film to initiate a thermal chemical reaction to form a metal oxide film on the substrate and vented exhaust gas.

The metal oxide film that is formed as the product may be TiO₂.

The metal precursor may be titanyl nitrate, supplied as is or formed in situ from other titanium salts.

The amino acid may be glycine. Generally, the amino acid contains only atoms selected from the group consisting of carbon, oxygen, nitrogen, and hydrogen. Put another way, the amino acid does not contain sulfur, phosphorus, chlorine, or selenium atoms.

The solvent may be water.

In embodiments, the metal oxide precursor solution further comprises an alcohol. The alcohol is, in particular embodiments, isopropyl alcohol, ethanol, methanol, and the like.

The metal oxide precursor solution may be preferably deposited by spin coating to enhance uniformity and control thickness.

The process may further comprise etching the substrate with an acid prior to depositing the metal oxide precursor solution on the substrate. Exemplary acids include HCl or HF. H₂SO₄ is also functional. HF or one of its salts is most preferred.

The coating may be dried at a temperature of 0° C. to 150° C. The drying rate can be enhanced using known techniques such as dry air, air/inert gas flow, vacuum, combinations of these, and the like. The preferred drying temperature is from 105° C. to 130° C. The objective is to dry the liquid without bubbling, spattering, cracking, and the like. The coating may be dried for a time period of seconds to minutes, though drying for a time period of hours to weeks is also functional.

The gel film may be heated to a temperature in the range of 200° C. to 250° C. to cause ignition of the dried film prepared above. The precise ignition temperature will vary with film composition and thickness. The gel film may be heated for a time period of several minutes, though seconds to hours are still effective. In particular embodiments, the gel film is heated for a time period of from 3 minutes to 59 minutes. In many cases, multiple gel film application cycles are preferred to build up a final film having a thickness sufficient to fully absorb illumination light during use (nominally about 1-2 micron). Thus, shorter times at firing temperature are most preferred. However, complete combustion and out-gassing of non-metal oxide film components is needed to minimize internal film defects that reduce internal film electrical conductivity and the associated back reactions noted previously. Sufficient time is needed for the film to intimately adhere the catalyst to a p-n junction or electron gathering film/deposit on the substrate.

In the metal oxide precursor solution, a molar ratio of the metal precursor to the amino acid may be from about 9:10 to about 5:1.

Also disclosed is a process for producing a TiO₂ film on an indium tin oxide (ITO) surface, the process comprising: providing a titanium oxide precursor solution comprising a titanyl nitrate, glycine, water, and isopropyl alcohol; depositing the titanium oxide precursor solution on the indium tin oxide surface to form a coating; drying the coating to form a gel film; and heating the gel film to form the TiO2 film on the indium tin oxide surface.

Also disclosed are electronic devices comprising a metal oxide film produced by the processes described above.

Also disclosed is a continuous process for producing a multilayered metal oxide film on a substrate, the process comprising: preparing a metal oxide precursor solution comprising a metal oxide precursor, an amino acid, and a solvent; depositing the metal oxide precursor solution on a substrate to form a coating; drying the coating to remove the solvent and form a gel film; heating the gel film to form a metal oxide film layer on the substrate; and repeating the depositing, drying, and heating steps multiple times in succession until the desired multilayered metal oxide film is obtained.

Also disclosed is a continuous process for producing a multilayered TiO₂ film on an indium tin oxide (ITO) surface, the process comprising: providing a titanium oxide precursor solution comprising a titanyl nitrate, glycine, water, and isopropyl alcohol; depositing the titanium oxide precursor solution on the indium tin oxide surface to form a coating; drying the coating to form a gel film; heating the gel film to form a TiO₂ film layer on the indium tin oxide surface; and repeating the depositing, coating, drying, and heating steps multiple times in succession until the desired multilayered TiO₂ film is obtained. These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a top view of an exemplary embodiment of a photolytic cell.

FIG. 2 is a second exemplary embodiment of a photolytic cell.

FIG. 3 is a perspective view of an exemplary photolytic device for oxygenating whole blood, designed for extra-corporeal usage.

FIG. 4 is a schematic diagram of an apparatus for oxygenating a confined volume.

FIG. 5 is a plot showing the increase in oxygen concentration attributed to photocatalytic oxidation of water using a photoanode constructed using the processes described herein.

### DETAILED DESCRIPTION

A more complete understanding of the components, processes, and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range of “from about 2 to about 10” also discloses the range “from 2 to 10.”

The disclosure relates to processes for forming metal oxide thin films on substrates. The substrates coated with metal oxide thin films are particularly useful in electronic devices, such as photolytic cells. In photolytic cells, the thin film must be coherent and clear, and with minimal cracks, pinholes, or other imperfections, because electrical conductivity and μ-peroxo linkage migration to the electrolyte are critical.

The processes generally comprise providing a metal oxide precursor composition comprising a metal oxide precursor, an amino acid, an oxidant, and a solvent; depositing the metal oxide precursor composition on a substrate to form a coating; drying the coating to remove the solvent and form a gel film; and heating the gel film to form a metal oxide film on the substrate.

The metal oxide precursor composition may be in the form of a solution, colloid, or suspension. The term “solution”, as used here, refers to a homogeneous mixture in which one or more solutes are dissolved into one or more solvents. The term “colloid”, as used here, refers to a mixture in which one or more particles are dispersed evenly throughout one or more liquids. The term “suspension”, as used herein, refers to a heterogeneous mixture in which one or more liquids contains one or more particles that are sufficiently large for sedimentation (i.e. to settle out of the liquid). In contrast to suspensions, the particles in a colloid will not settle out. In specific embodiments, however, the metal oxide precursor composition is a solution, particularly an aqueous solution.

The metal precursor may generally be any metal-containing compound which desirably forms a metal oxide film. Exemplary metals include titanium (Ti), vanadium (V), iron (Fe), zinc (Zn), molybdenum (Mo), nickel (Ni), cobalt (Co), tungsten (W), gallium (Ga), indium (In), tin (Sn), bismuth (Bi), copper (Cu), manganese (Mn), rare earth elements, and the like, either singularly or in any combination. In some embodiments, the metal precursor is a nitrate, such as titanyl nitrate (TiO(NO₃)₂). In other embodiments, the metal precursor contains a nitrate ion, nitrite ion, perchlorate ion, chlorate ion, azide ion, and the like, alone or in combination. Non-oxidizing anions of the metals can also be used provided that they are combustible by an oxidant to form gases that are released or that they form ions/atoms that become part of the metal oxide film. Examples are carboxylate anions, such as aliphatic acid salts of oxalic acid, acetic acid, or formic acid. In these cases the oxidant is included as a separate salt such as ammonium nitrate, potassium nitrate, uranium nitrate, provided the nitrites of such compounds and any combination of these that also comply with the molar ratios given above. In particular embodiment, the metal precursor is a blend of (i) a non-nitrate-containing titanium compound and (ii) a nitrate-containing compound.

The titanyl nitrate may be formed by adding titanium n-butoxide (Ti(C₄H₉O)₄) to water and mixing vigorously. Titanium oxyhydroxide (TiO(OH)₂) and butanol (C₄H₉OH) will form as shown in equation (1):

Ti(C₄H₉O)₄+3H₂O→TiO(OH)₂+4C₄H₉OH (1).

The hydroxide analog will form a white precipitate.

Next, nitric acid is added, the precipitate dissolves, and titanyl nitrate is formed according to equation (2):

TiO(OH)₂+2HNO₃→TiO(NO₃)₂+2H₂O (2).

The metal oxide precursor composition also includes an amino acid. An amino acid is a compound of the formula H₂N—CHR—COOH, where R is a sidechain. The term “amino acid” includes natural amino acids produced by living animals (i.e. proteinogenic) and artificial (i.e. homogenic) amino acids. In some embodiments, the preferred amino acid is glycine (H₂NCH₂COOH). In other embodiments, the amino acid contains only atoms selected from the group consisting of carbon, oxygen, nitrogen, and hydrogen. Put another way, the amino acid does not contain sulfur, phosphorus, chlorine, or selenium atoms. This is due to the combustion reaction which occurs, and will be described further herein. Suitable amino acids include Ala, Asp, Gly, Glu, Phe, His, Ile, Lys, Leu, Asn, Pro, Gln, Arg, Ser, Thr, Val, Trp, and Tyr.

In the metal oxide precursor solution, the molar ratio of the metal precursor to the amino acid is from about 9:10 to about 5:1.

The metal oxide precursor composition also includes a first solvent. Generally, the solvent is water. However, in some embodiments, a second solvent which is an alcohol may be added as well. In particular embodiments, the alcohol is isopropyl alcohol. The ratio of the first solvent to the second solvent may be about 3:2. In this manner, metal ion alkoxides of these alcohols can be used with convenience.

Generally speaking, the substrate should be cleaned and degreased before being coated with the metal oxide precursor composition. For example, a substrate that comprises quartz may be cleaned and degreased by swirling in toluene, rinsing with fresh toluene, air drying, soaking for about 20 minutes in warm (i.e. >40° C.) Micro® cleaning solution, rinsing thoroughly with water, soaking for two minutes in water to diffuse away any surface adherent contaminants and residual cleaner, and rinsing again with high purity deionized water (HPDI). A total of five rinses is preferred. Next, the substrate is soaked in concentrated (i.e. ˜95%) sulfuric acid (H₂SO₄) to attack and dissolve normally insoluble organic and inorganic surface residues and cause a silanol surface to form where any cations other than H⁺ are exchanged off of the surface. The substrate is then rinsed again with a large excess of HPDI water to remove the sulfuric acid and these cationic impurities. To verify surface cleanliness, a water break test is performed by taking a cleaned and dried substrate and tilting it in a 15° angle from the vertical position, then spraying the substrate two to three times while observing the flow of rinse water across the substrate. If the substrate is clean, i.e. free of oily residue, the water will not adhere to the substrate. If oil or grease remains on the substrate, the water will bead on the portion of the substrate that contains oil or grease. If the water break test fails, then the substrate should be further cleaned. The water used is preferably high purity deionized water (HPDI) and five rinses or the continuous equivalent is used. All liquids are made dust-free by filtration prior to use.

Optionally, the surface of the substrate may be etched with an acid prior to depositing the metal oxide precursor solution on the substrate. The surface can be etched by treating with hydrofluoric acid (HF) or an HF releaser, or with the less preferred hydrochloric acid (HCl), or the like to form surface silanol (Si—OH) groups. The etching may also help with passing the water break test.

The substrate may also be formed of quartz with an indium-tin oxide (ITO) layer and/or p-n junction layer on the quartz. Such a substrate may be cleaned by soaking for two minutes in warm, dilute ALCONOX® solution, wiping (scrubbing) with a lint-free cloth, rinsing with water, soaking in water, rinsing in water again, soaking in isopropyl alcohol, rinsing with isopropyl alcohol, and air drying (desirably in a dust-free environment).

Preferably, the substrate is coated with the metal oxide precursor solution immediately or within a few hours of cleaning. After longer periods, a layer of grease and/or dust may re-form on the substrate. Therefore, storage of cleaned surfaces is not recommended.

The substrate may be coated with the metal oxide precursor solution by a variety of liquid deposition techniques including dipping, spraying, brushing on, using doctor blades, recirculated fluid, and the like. In some embodiments, the clean ITO-coated substrate is placed on the center of a spin coater after taping of electrical conduction points. A vacuum is used to hold the substrate in place. The entire top surface of the flat substrate is coated with the filtered, “dust-free” precursor solution. A plastic syringe and syringe filter which remove particles having a particle size of about 0.2 μm or greater may be used as this filtration/application device. Next, the substrate is spin coated, for example, at about 1000 rpm for about 60 seconds. The coating is then dried in an oven to drive off remaining solvent, to ensure solvolysis of the metal ion alkoxide by water, and to establish a crosslinked gel film. In embodiments, the coating is dried at a temperature of from 0° C. to 150° C., most preferably from 100° C. to 125° C. In embodiments, the coating is dried for a time period lasting from seconds to minutes, though hours to weeks is also functional. A specific time range may be from 1 second to 59 minutes.

The gel film is then heated to form a metal oxide film on the substrate. Heating initiates nitrate ion oxidation of the organic components, thereby forming gases and leaving the amorphous metal oxide on the substrate. In embodiments, the gel film is heated to a temperature of from 200° C. to 250° C. In embodiments, the gel film is heated for a time period of several minutes, though seconds to hours are still effective. The gel film may be heated, for example, at about 225° C. for about 15 minutes. The substrate with metal oxide thin film may then be allowed to gradually cool to about ambient temperature.

The metal ion loading of the metal oxide precursor composition needs to be sufficient to leave a surface metal oxide layer after firing or combustion of sufficient thickness such that a continuous metal oxide film results on the coated surface area, but not so high that the coating cracks or crazes excessively. Most desired is a continuous uniform film, but this is not required. Best films are formed by depositing very thin films in rapid succession. Forming films from individual, self-assembled monolayers is effective as well.

Equation (3) shows the overall combustion reaction for forming a TiO₂ thin film from a metal oxide precursor solution comprising titanyl nitrate and an amino acid:

pTiO(NO₃)₂+qH₂N—CH(R)—COOH→rTiO₂+sCO₂+tH₂O+vN₂ (3).

As noted above, many different amino acids, both natural and homogenic, may participate in the combustion reaction that forms the metal oxide film, and they can be used in any combination consistent with the molar balance of Reaction (3). Table 1 below provides a list of many different amino acids and the resulting values for p, q, r, s, t, and v in Equation (3).

TABLE 1

| Amino Acid | R | p | q | r | s | t | v |
|---|---|---|---|---|---|---|---|
| Ala | —CH₃ | 3 | 2 | 3 | 6 | 7 | 4 |
| Asp | —CH₂COOH | 3 | 2 | 3 | 8 | 7 | 4 |
| Glu | —CH₂CH₂COOH | 21 | 10 | 21 | 50 | 45 | 26 |
| Phe | —CH₂C₆H₅ | 43 | 10 | 43 | 90 | 55 | 48 |
| Gly | —H | 9 | 10 | 9 | 20 | 25 | 14 |
| His | —CH₂—C₃H₃N₂ | 29 | 10 | 29 | 60 | 45 | 44 |
| Ile | —CH(CH₃)CH₂CH₃ | 33 | 10 | 33 | 60 | 65 | 38 |
| Lys | —(CH₂)₄NH₂ | 17 | 5 | 17 | 30 | 35 | 22 |
| Leu | —CH₂CH(CH₃)₂ | 33 | 10 | 33 | 60 | 65 | 38 |
| Asn | —CH₂CONH₂ | 9 | 5 | 9 | 20 | 20 | 14 |
| Pro | —CH₂—CH₂—CH— | 5 | 2 | 5 | 10 | 9 | 6 |
| Gln | —CH₂CH₂CONH₂ | 12 | 5 | 12 | 25 | 25 | 17 |
| Arg | —(CH₂)₃NH—C(NH)NH₂ | 17 | 5 | 17 | 30 | 35 | 27 |
| Ser | —CH₂OH | 13 | 10 | 13 | 30 | 35 | 18 |
| Thr | —CHOH—CH₃ | 19 | 10 | 19 | 40 | 45 | 24 |
| Val | —CH(CH₃)₂ | 27 | 10 | 27 | 50 | 55 | 32 |
| Trp | —CH₂—C₈H₆N | 26 | 5 | 26 | 55 | 30 | 31 |
| Tyr | —CH₂—C₆H₄OH | 41 | 10 | 41 | 90 | 55 | 46 |

In some embodiments, multiple metal oxide films may be formed on a substrate by repeating the above steps until a desired thickness is achieved. Thinner films are less prone to pinholes, adhesion problems, or cracking from exiting gases. In order to enhance layer-to-layer bonding in a multilayer film, the construction of each of the layers should be performed in rapid sequence. Notice that this fabrication method allows different metals to be applied in separate layers. This feature allows tuning the overall photocatalyst activity of a final multilayered metal oxide film to broader ranges of illumination wavelengths and hence higher quantum yields.

Once all of the metal oxide films have been applied, the coating may optionally be annealed to form a polycrystalline metal oxide microstructure, e.g. the anatase form of TiO₂. However, this annealing causes shrinkage that may result in cracking or pinhole formation, or if heated too quickly may cause rapid expulsion of entrained moisture, solvents, and gases if the transformation from amorphous metal oxide to crystalline film is too rapid. Therefore, to avoid these potential defects, sufficient metal-oxide content must be used for each layer applied so there is enough final mass to extend the metal oxide across the entire substrate surface to a depth of at least about 50 angstroms (Å).

The substrate and metal oxide film produced by the process described above may be used in a photolytic device such as a photolytically driven electrochemical cell (PDEC). Photolytic devices may be prepared in this manner that operate similarly to the photosynthesis process that takes place in green plants. In the anode compartment, the apparatus utilizes the photolytic cell and light energy to simultaneously generate oxygen, hydrated protons, and electrical energy. In the cathode compartment, the photolytic cell can also use light energy to remove carbon dioxide from the environment and convert CO₂ gas to a carbonate or oxygenated hydrocarbon solid, solution, or liquid. One or more photolytic cells can be included in the apparatus depending on the quantity, quality, processing rates, etc. of desired gas exchange, generated electrical current (voltage), or hydrated protons.

Generally, the light energy used by the photolytic cell is ultraviolet (“UV”) light (wavelengths of 10 nm to 400 nm) or visible light (400 nm to 780 nm), with UVA (wavelengths of 300 nm to 400 nm) being preferred and the laser form being the most preferred. However, the light energy can also be broad-band. The light can be received by the way of a face illuminated clean plate, a “light pipe” fiber optic cable, or an attenuated total reflectance (ATR) link, end (face) on, edge on, and the like. The transparent material carrying the light can be vacuum, quartz, silica glass, or a clear plastic material such as polycarbonate or acrylic.

In the apparatus, dissolved oxygen is generated in the anode compartment from an aqueous solution by means of the light dependent chemical reactions, photolysis and disproportionation. This is followed by the removal or clearing of carbon dioxide in the cathode compartment by the formation of electrochemically reduced carbon or higher carbon compositions such as hexose sugar, electrochemically reduced carbon compounds such as formate, oxalic acid, methanol, and the like, or simply captured by reaction with cathodically produced OH⁻ ions to form carbonates.

In this regard, photolysis is the initiation of a photochemical reaction that results from the absorbance by a light-activated catalyst (i.e. photocatalyst) of one or more quanta of radiation. Here, water from an aqueous solution (“anolyte”) is converted into oxygen by the light-activated catalyst, such as a semiconducting metal oxide. The metal oxide is utilized as a photo-absorbent material or a photo-absorption element. The light-activated catalyst is photolytically irradiated to convert water into hydrogen ions, peroxide or other forms of an oxygen gas precursor (active oxygen, “AO”), and electrons by the absorption of one or more quanta of electromagnetic radiation that moves (“excites”) an electron in the oxide into the semiconductor's conductance band, thereby generating “free” electrons. The free electrons generated are then electrically conducted away to avoid reversal of the reaction, optionally utilized to drive various electrical devices such as a pump, or used to capture CO₂ and optionally, “fix” the CO₂ in electrochemically reduced carbon compounds.

For example, it has been found that active oxygen can be generated in one embodiment of the present disclosure by the use of the anatase form of titania (TiO₂(a)) as the light absorbent material in the anode compartment. The photo energy of light, such as ultraviolet laser light (about 365 nm), selectively excites TiO₂ semiconductor transition (about 350-390 nm band, or about 3.1 eV) with minimal material radiation or transmission. Special dopants or catalyst film layers of varying composition may adjust this wavelength, in order to reduce the energy requirement and even to allow activation within the range of visible light, when tungstates and/or dye sensitizers are used. The light energy produces charge separation in the anatase form of TiO₂, which then produces active oxygen (AO) and free electrons. The free electrons are then subsequently electrically conducted away due to the semi-conducting property of the anatase and by the use of a continuous film photocatalyst. Alternatively, other suitable light absorbent materials can also be utilized in the present disclosure at various wavelengths provided that the energy is sufficient to produce active oxygen (wavelength energies of about 740 nm). Though DO is formed spontaneously from the AO precursor, the rate of DO formation from the active oxygen produced during photolysis can also be converted by means of manganese dioxide (MnO₂), or other disproportionation catalytic agents and/or processes, into dissolved oxygen (DO) and water. These AO disproportionation catalysts can be located within or on the photocatalyst, exist in the aqueous solution, or both.

Carbon dioxide can also be removed (“fixed”) from the environment or confined breathing air space by the means of a series of carbon-containing molecule building reactions. These reactions occur in the cathode compartment of the apparatus to produce removable and/or recyclable carbonate solids or liquids. Hydrogen ions produced from the aqueous solution of the anode compartment are preferentially used in the carbon dioxide fixation to form electrochemically reduced oxygenated hydrocarbon products.

A brief description of the pertinent reactions involved in the anode compartment for generating oxygen using anatase as the light-absorbent material (i.e. photolytic catalyst) and MnO₂ as the disproportionation catalyst) is provided below:

Photolysis:

$$2 {H}_{2} O + hv {\to }^{{TiO}_{2} ( s ) \\ ( anatase )} “ {H}_{2} {O}_{2} ” + 2 {H}^{+} + 2 {e}^{-}$$

where H₂O₂ is used to illustrate “active oxygen” intermediate located on the photocatalytic surface adjacent the anolyte. The “H₂O₂” is formed by protonation of Ti-peroxide by water in the anolyte.

Disproportionation:

$$“ {H}_{2} {O}_{2} ” {\to }^{{MnO}_{2} ( s )} 1 \text{/} 2 {O}_{2} ( DO ) + {H}_{2} O$$

DO=dissolved oxygen, which is used directly to oxygenate deoxyhemoglobin in blood gas maintenance. It is also readily converted to gaseous oxygen, O_{2(g)}, for breathable air maintenance applications.

The various components of the flow-through photolytic cells and apparatuses of the present disclosure are first described below. Next, their use in various processes will be discussed.

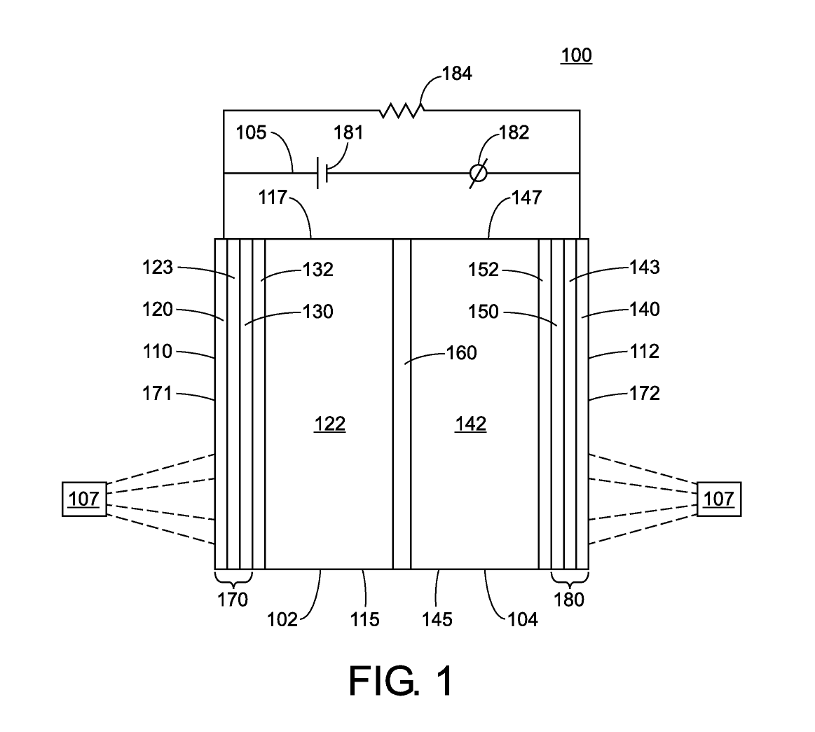

FIG. 1 is a top view of an exemplary embodiment of a photolytic cell. The photolytic cell 100 includes an anode compartment 102 and a cathode compartment 104. The anode compartment contains a transparent substrate or window 110, through which light can pass in order to reach the interior of the photolytic cell. The anode compartment also includes an anode or anode conductor layer (“current collector”) 120. The anode may be substantially light transmissive and electrically conductive.

Disposed upon the anode conductor layer is a coating containing a first light-activated catalyst 130. An optional anode p-n junction 123 may be placed between the anode 120 and the coating 130. In some embodiments, the coating 130 may also contain a disproportionation catalyst, as described further herein, either dispersed within the coating of the first light-activated catalyst 130 or as a layer 132 disposed upon the first light-activated catalyst 130. The cathode compartment also contains a transparent substrate or window 112, through which light can pass in order to reach the interior of the photolytic cell. The cathode compartment also includes a cathode or cathode conductor layer 140 for electron distribution across the cathode reaction area. The cathode may be substantially light transmissive, i.e. light can pass through the cathode. Disposed upon the cathode is a cathode p-n junction 143 and disposed upon the cathode p-n junction 143 is a coating containing a second light-activated catalyst 150. Both the cathode p-n junction 143 and the coating 150 are optional. This coating may also contain a high H₂ overpotential or hydrogenation catalyst, or the like, selected to facilitate the desired cathode reduction electrochemistry, either dispersed within the coating or as a separate layer 152 upon the second light-activated catalyst. The anode 120 and cathode 140 are electrically connected (reference numeral 105) to allow electrons to flow from the anode to the cathode. A cation exchange membrane or proton exchange membrane 160 is located between the anode 120 and the cathode 140, and allows protons to move from the anode compartment into the cathode compartment. The anode compartment also contains an anolyte flowpath 122, while the cathode compartment also contains a catholyte flowpath 142, to allow liquids/gases to flow through the compartments and their respective electrodes. The anode compartment contains an inlet 115 and an outlet 117, and the cathode compartment contains an inlet 145 and an outlet 147.

In operation, photons from a light source 107 pass through the substrate/windows 110, 112 as well as the anode 120/cathode 140 and p-n junctions 123, 143, activating the first light-activated catalyst 130 and the second light-activated catalyst 150. Depending on the specific photocatalyst composition selected, the first light-activated catalyst either directly converts water in the anolyte to dissolved oxygen, or converts water to active oxygen and hydrogen ions with the disproportionation catalyst subsequently converting the active oxygen into dissolved oxygen (DO). The anolyte, containing an increased amount of oxygen, exits the anode compartment by way of outlet 117 and may be pumped to an oxygen gas separator (not shown) to obtain gaseous oxygen for use. The electrons released from the conversion of water to oxygen flow from the anode to the cathode via electrical connector 105. The electrical connector can be located outside of the cell (as depicted) or through electrically insulated and liquid tight connectors (not shown) within the fabricated cell. Thus, the electrons do not react with the active oxygen to cause a back reaction and the reformation of water. Polarizing the cell externally using a battery or other voltage source 181 or internally using a p-n junction 123 encourages direction of electrical current flow. Hydrogen (H⁺) ions flow through the cation exchange membrane 160 to the cathode compartment 104 for reaction at the cathode 140, the disproportionation catalyst 152, or the second light-activated catalyst 150. The electrons and H⁺ ions are used at the cathode to reduce CO₂ into other products, such as oxygenated and/or nonoxygenated hydrocarbons, carbon monoxide (CO), and H₂. The specific reaction product depends on the material used for the cathode components 140, 150, 152, as well as the operating cathodic voltage and current density applied.

Alternatively, the photolytic cell may be considered as comprising a photoanode 170 and a photocathode 180. The photoanode comprises an anode conductor (“current collector”) layer 120, an optional anode p-n junction 123, and a first light-activated catalyst 130. The photocathode comprises a cathode conductor (“current distributor”) layer 140, an optional cathode p-n junction 143, and an optional but preferred second light-activated catalyst 150.

The various components of the flow-through photolytic cells of the present disclosure are described in more detail below:

1. Transparent Substrate or Window

The transparent window 110, 112 can be formed from glass, silica glass, quartz slides, fiber optic quartz, etc. that preferably also contains an anti-reflective coating (ARC). Glass is useful in forming the UV/Vis transparent window provided that the UV transparency is adequate at the wavelength needed. Quartz slides are also useful because of its high UV transparency. Generally, the transparent window is used to form the back, side, or bottom of the photolytic cell. Edge illumination through the transparent window can optionally include a lens, waveguide, or attenuated total reflective (ATR) surfaces.

The transparent window can further include a waveguide. A waveguide uniformly distributes photons (hν) from the light over the surface of the light-activated catalyst. Particularly, the waveguide causes the light photons to travel in a path so that the photons maximally contact the entire layer of the light-activated catalyst. Light enters the waveguide in the side of the transparent window generally parallel to the surface of the light-activated catalyst. The waveguide allows for maximum photon contact with the light-activated catalyst without direct illumination of the transparent window. The waveguide provides additional efficiency to light used in the photolytic cell because the light can be spread across the entire surface of the light-activated catalyst. It also enables efficient stacking of one or more adjacent located cells.

Generally, the transparent window should allow the passage of light wavelengths that will activate the light-activated catalyst. In particular embodiments, UV light of wavelengths from 350 nanometers to 390 nm should be able to pass through the transparent window. However, other wavelengths may be desirable, depending on the composition of the light-activated catalyst. The transparent window may allow a broad range of wavelengths to pass, or in some embodiments allow only a narrow range of from about 10 to 50 nanometers to pass.

In addition, in the present photolytic cell, both light-activated catalysts 130, 150 should be exposable to light. There is no specific need for two separate transparent windows as long as this requirement is met. For example, FIG. 1 currently depicts the anode 120 and the cathode 140 as being on opposite side walls 171, 172 of the photolytic cell 100, with each wall containing a transparent window 110, 112. However, both the anode 120 and the cathode 140 could be illuminated by a single transparent window in the top or bottom walls (not visible) of the photolytic cell 100.

In other embodiments, the same light transparent wall could illuminate two anodes or two cathodes stacked back-to-back.

Or, in other embodiments, both the anode and the cathode could be located on the top or bottom wall, and simply be separated by the cation exchange membrane 160.

2. Anode or Anode Conductor Layer

The anode or anode conductor layer (“current collector”) 120 conducts electrons formed from the reaction of water to oxygen out of the anode compartment 102 via the conductor link 105 and into the cathode compartment 104 via cathode 140. This prevents the electrons from back-reacting with the oxygen to reform water, thereby allowing maximum formation of oxygen for a given amount of photons.

The anode conductor layer can be formed in at least two different ways. The anode layer can be formed by attaching a thin film of uniform metallic conductor to a substrate using vapor deposition. In particular embodiments, the anode conductor layer is applied or attached to one side of a transparent window. In embodiments, the anode conductor layer is formed from a conductive material that is transparent to light when it is a thin film, such as gold, titanium, or indium tin oxide (ITO). Most preferred are ITO materials and the like. Gold remains metallic at all conditions, but can be very efficient at UV light blockage or reflection. Titanium can be oxidized to TiO₂ by adding O₂ to the deposition chamber to yield a possible catalyst layer with excellent adhesion. The film preferably has a thickness of less than about 0.2 μm.

The anode conductor layer can also be formed by using photo-resist technology. Under photo-resist based technology, grids or vias are prepared with masks using vapor deposition, etching, and electroless plating. Conductor line spacing, width and thickness optimization may be required to prevent excessive attenuation, and provide sufficiently close conductive areas to sweep electrons away (“current collecting”) from the light activated catalyst layer.

3. Light-Activated Catalyst

A first light-activated catalyst 130 is coated onto the anode 120 or the anode p-n junction 123. Generally speaking, the purpose of the first light-activated catalyst is to selectively absorb photons and to react with water to form dissolved oxygen, a reactive molecule, or a free radical oxygen intermediate that is ultimately converted to dissolved oxygen. The term active oxygen (AO) in the present application defines any reactive molecule (non-free radical) or free radical oxygen intermediate formed in the photolytically catalyzed reaction of water that is ultimately converted to dissolved oxygen. These intermediates are known in the prior art. The active oxygen formed is in the form of a peroxide, such as titanium peroxide, titanium hydroperoxide, hydrogen peroxide, a peroxide ion salt, hydroxyl free radical, super oxide ion, ozone, etc., and can be converted into dissolved oxygen in the presence of a disproportionation catalyst. The form of the active oxygen depends on the light-activated catalyst used. Alternatively, water may be photolytically converted directly into dissolved oxygen without first forming an active oxygen.

Several different catalysts can be employed as the first light-activated catalyst for producing dissolved oxygen photochemically. One catalyst that can be used to photochemically produce oxygen is zinc oxide (ZnO), which produces peroxide (H₂O₂) directly from water at blood pH. H₂O₂ is an excellent form of active oxygen for providing sufficient potential diffusion distance, and also for the disproportionation reaction into dissolved oxygen and water via a solid MnO₂ catalyst (similar to green plant O₂ generation site), occurring photochemically at <340 nm by way of efficient metal ion assisted disproportionation with catalase and other hydroperoxidases. Zinc oxide film has other positive attributes including known film formation technology, low toxicity concerns, and low cost.

An additional catalyst that can be used to photochemically produce dissolved oxygen is tungstate (WO₃), which yields oxygen (O₂) directly from water without the need to first produce an active oxygen species. Oxygen is generated stoichiometrically and the “back reaction” is unfavored so that there is not significant competition to the direct formation of dissolved oxygen. Only visible light is needed to generate dissolved oxygen from WO₃, no more than about 496 nm. WO₃ films present low toxicity concerns.

Another catalyst suitable for reacting with water is titanium dioxide, TiO₂ (anatase). One advantage of TiO₂ is that it is semiconductive and in combination with a titanium film as the anode conductor, allows electrons to be removed efficiently from the area near the catalyst itself to ultimately obtain good dissolved oxygen production and minimize any back-reaction that would reform water. Irradiation of TiO₂ with light also presents low toxicity concerns. TiO₂ provides very high insolubility and kinetic inertness to minimize dissolution and fouling during use and maintenance. Preferably, UV light is chopped or pulsed during TiO₂ irradiation to allow time for the above described sequence of chemical reactions to occur. Since photochemical reactions are essentially instantaneous, with continuous irradiation (not chopped or pulsed) electrons may accumulate and cause a back-reaction to form water from oxygen and H⁺ ions. A pause in the irradiation allows time for slower reactions to occur. It should be noted that the pulse rate of the light is still in the microsecond to millisecond range, so that there is little effect on oxygen production rates.

A further light-activated catalyst is a semiconductor powder (SCP)-filled light-transparent thermoplastic film. SCP-filled thermoplastic film is relatively inexpensive to manufacture and form into shape. SCP film is easily moldable, extrudable, cut and machined. SCP can be used very efficiently when applied to a surface, and also has low toxicity concerns. Optimized commercial products (conductive plastic filler powders) are available with good properties for dispersion, particle-to-particle electrical conductivity, and resistance to sloughing off.

The following conditions may be used for each of the above-mentioned light-activated catalysts. First, application of a bias voltage can be omitted provided the PDEC cell design selected is self polarizing. Otherwise a small bias voltage (e.g. a few millivolts up to a few volts DC) can be applied during the power up phase of the operation, continually, or as needed. In addition, a passive DC bias voltage can be built internal to the PDEC cell using a P-N junction as described above. When applied, the bias voltage is used to help ensure that electrons are quickly conducted away from the production site. Second, a pulsed illumination, rather than of a continuously applied illumination, may allow necessary secondary chemical reactions to occur since the secondary chemical reactions are slower than the photochemical reactions and enhance photoyields by allowing time for the excited electrons to exit the system and so not be present for regeneration of starting material, i.e. H₂O.

Of the above-mentioned catalysts, the TiO₂ (anatase) catalyst followed by a second metal catalyst for disproportionation is the most preferred. It is known that TiO₂ is an efficient UV light (hν) acceptor at wavelengths<390 nm, resulting in the formation of active oxygen in the form of titanium peroxide that leads readily to O₂ formation as DO from sorbed water via H₂O₂ disproportionation.

The TiO₂ light-activated catalyst layer can be formed in a variety of ways. The TiO₂ layer can be formed by sol gel, drying and baking. A product under the trademark LIQUICOAT® from Merck & Co., Inc., which hydrolyzes Ti(OR)₄ type material in water to form TiO₂ and 4ROH can be used to form the TiO₂ layer under a sol gel/drying/baking process. TiO₂ can also be formed from preparing an anatase suspension from dry powder, then dipping, drying, and baking the suspension to form the TiO₂ layer. Another way the TiO₂ layer can be formed is by e-beam evaporating titanium and subsequently exposing the titanium to O₂ within a deposition chamber. The TiO₂ layer can also be formed by adding titanium salt to water and adjusting the pH to ˜2-7 to form a suspension, then dipping the substrate into the suspension and allowing the suspension to dry.

Although not being bound by theory, it is believed that the O₂ generation of the invention occurs by the following theoretical model. Water bonds to the surface of the TiO₂ catalyst and is oxidized to hydrogen peroxide when reacting with internal titanium peroxide formed during photolysis. Titanium peroxide represents the initial form of the active oxygen generated by the photolytic process. The active oxygen formed could generally be in the form of a superoxide, hydrogen peroxide, or a hydroxyl free radical. However, all of these forms of active oxygen produced have sufficient thermodynamic driving force to form active oxygen from water. For the TiO₂(a) catalyst at neutral pH, it is possible that these highly reactive forms of oxygen either back-react with photoelectrons to form water, or rapidly dimerize to form μ-peroxotitanium(IV) and hydrogen ions. These H+ ions are valuable for CO₂ level control by fixation. The μ-peroxotitanium(IV) complex can be reacted with another water molecule to form H₂O₂.

H₂O₂ is an excellent form for the active oxygen species as it readily migrates and is easily catalyzed to disproportionate into dissolved oxygen and water. H₂O₂ can be rapidly converted to dissolved oxygen in 100% yield using many different methods: thermally; metal ion catalysis; particulate/surface catalysis; base catalysis; and free radical reaction with reductant initiation. Preferably, metal ion catalysts, such as MnO₂ (s), provide an efficient catalyst for H₂O₂ disproportionation to water and O₂, using thin film substrate constructs. It has been found that DO is produced from the H₂O₂ even without the added disproportionation catalyst layer or agent. However, the highest DO production rates are believed to be achievable using a H₂O₂ (AO) disproportionation catalyst. Hence the use of such a catalyst is preferred but optional.

Zinc oxide, ZnO, releases peroxide as the active oxygen more readily than does TiO₂. Less acidic metal ions under the Lewis acid/base theory definition cannot sufficiently stabilize the highly alkaline peroxide ion relative to water protonation (pKₐ₁ of H₂O₂ is 11.38 (25° C.)) to form it within the solid phase, and so hydrogen peroxide, H₂O₂, is readily formed from ZnO. ZnO films and particles can be prepared in a number of ways with varying but controlled composition, morphology and porosity. For example, mirrors of zinc, doped zinc, and zinc alloys and can be sputtered down onto an optically transparent support, followed by oxidation with O₂(g). This treatment produces a metal/metal oxide (Zn/ZnO) film. Another highly effective approach to semiconducting ZnO-based films is to utilize a process for optical glass coatings described in U.S. Pat. No. 4,880,772. Metallic zinc films, pure or alloyed, are also readily produced by electrolytic metal plating processes.

Tungstate only requires visible light to produce dissolved oxygen, and produces dissolved oxygen directly without requiring a second catalyst to form dissolved oxygen. The lower photon energy requirement for WO₃ is due to the smaller band gap of 2.5 eV versus at least 3.2 eV for TiO₂(a). As with the TiO₂ anatase system, high yields are possible with the WO₃ catalyst. The production of O₂ increases very significantly if RuO₂ (ruthenium oxide) is placed on the surface of the WO₃. This is consistent with the fact that RuO₂ is a known good catalyst for O₂ production and so represents a route to improving other approaches.

The amount of active oxygen lost to side reactions can be minimized by introducing an active oxygen carrier molecule into the liquid or solid medium flowing through the anolyte flowpath. Agents suitable for use as this active oxygen carrier molecule can be selected from two groups, those that readily form organic peroxides, and those that form “stable” (i.e. long-lived) free radicals. The active oxygen carrier molecule captures the hydroxyl free radical in a longer lived species, and is labeled as species “D” in the following chemical reaction:

D+.OH->D*

where D can be RC(O)OH:

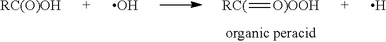

### or D can be R₃COH:

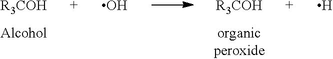

or D can be a free radical scavenger that forms a stable free radical:

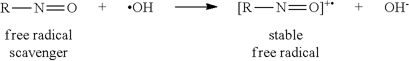

or D can be 2,6-di-tertbutyl phenol:

t-Bu-Ar—OH+.OH->t-Bu-Ar—O.+H₂O

The 2,6-di-tertbutyl phenol is the most desired D species, as a strongly reducing .H radical is not formed that would consume other useful products in wasteful reactions, regenerate the starting materials, and result in a low photochemical yield.

In other embodiments, the photolytic coating containing the first light-activated catalyst may also include a disproportionation catalyst. Put another way, a first disproportionation catalyst may be disposed upon the first light-activated catalyst. The disproportionation catalyst is used to convert active oxygen into dissolved oxygen and includes a metal ion capable of redox cycling, such as Fe^{II}, Fe^{III}, Cu^{I}, Cu^{II}, Co^{II}, Co^{III}, Mn^{II}, Me^{III}, Mn^{IV}, etc. In particular embodiments, the disproportionation catalyst is a metal oxide of such metal ions, such as manganese dioxide, MnO₂. The MnO₂ catalyst is most preferred because it forms dissolved oxygen efficiently and is not highly selective of the active oxygen form. These catalysts could also be in the soluble form, dissolved in the anolyte. For example, whole blood contains the Fe-protein “transferrin” which is an excellent catalyst. This is one reason why a disproportionation catalyst need not be included on the anode/cathode.

One way to facilitate the conversion of active oxygen to O₂ is by doping the surface of the TiO₂ anatase with manganese (Mn). Surface doping the TiO₂ with Mn provides a highly productive active oxygen to O₂ conversion catalyst. Active oxygen disproportionation is rapid when dropped on a Mn-doped anatase. Alternatively, active oxygen can also be converted to O₂ by placing MnO₂ on the surface of the anatase in conductive form. In this form, electrons are catalytically passed from water to the active oxygen region of the anatase. Such an arrangement more closely mimics photosynthesis O₂ production.

4. Proton or Cation Exchange Membrane

The cation exchange membrane 160 allows for the diffusion of cations in the photolytic cell from the anode compartment 102 to the cathode compartment 104. Suitable cation exchange membranes are commercially available under the trademark NAFION® and are available from E.I. DuPont Nemours Inc. NAFION® cation exchange membranes are a perfluorosulfonic acid/PTFE copolymer in an acidic form. Battellion™ Ion Exchange membrane is a newly developed cation exchange membrane that gives high current density at low temperature. Although NAFION® cation exchange membranes are a preferred membrane, one skilled in the art would recognize that other cation exchange membranes are also suitable in the photolytic cell. In particular, the cation exchange membrane allows cations, such as sodium ion (Na⁺) or hydrogen (H⁺), to diffuse through the membrane for subsequent reaction in the cathode compartment. Other cations may include K⁺, Mg²⁺, Li⁺, NH₄⁺, and NR₄⁺.

5. Second Light-Activated Catalyst

As described above, the first light-activated catalyst 130 is coated onto the anode p-n junction 123. Similarly, a second light-activated catalyst 150 is coated onto the cathode p-n junction 143. While the purpose of the first light-activated catalyst is to react with water to form dissolved oxygen, the purpose of the second light-activated catalyst is to react with water to obtain hydrogen ions and electrons that can be used to reduce CO₂, either as a gas or in one of its water soluble forms (HCO₃⁻, CO₂ (aq), and the like). Practically speaking, however, both purposes can be obtained with the same catalyst and with only one p-n junction located at the anode or in the electrical path between the anode and the cathode. The treatment of the resulting oxygen or hydrogen can simply differ depending on the compartment of the photolytic cell. Thus, any of the materials described above as being suitable for the first light-activated catalyst 130 are also suitable for the second light-activated catalyst 150. The photolytic coating containing the second light-activated catalyst may also include a disproportionation catalyst. Put another way, a second disproportionation catalyst 152 may be disposed upon the second light-activated catalyst. This second disproportionation catalyst should have a high hydrogen overpotential, and/or be selected to facilitate the desired reduction electrochemistry at the cathode. The presence of the second light-activated disproportionation catalyst at the cathode allows for the additional production of voltage to accomplish difficult reductions when using the electrons provided from the anode and the H⁺ ions that pass through the cation exchange membrane 160 into the cathode compartment 104.

6. Cathode or Cathode Conductor Layer

As previously noted, CO₂ is reduced at the photocathode 180 into other products, such as oxygenated and/or nonoxygenated hydrocarbons, carbon monoxide (CO), and H₂. The specific reaction product depends on the material used for the cathode components 152, 150.

The cathode may be formed from platinum (Pt) to obtain H₂ only as the reaction product. When the cathode is formed from carbon, particularly glassy carbon, the reaction product is organic compounds. Cathodes formed from metals with high hydrogen gas overpotential, namely Cd, Pb, TI, and Sn, give formate (HCOO⁻) and/or formic acid as a product. Cathodes formed from Ag and Cu give CO as a reaction product. The use of molybdenum results in the formation of lower alkanes or alkenes, such as CH₄ and C₂H₆. When the cathode is formed from Ni or Fe, the resulting reaction product is H₂ gas.

7. Battery/Current Regulator

The photolytic cell can include a battery 181, current regulator 182, or resistor 184. An electrical circuit 105 including the bias voltage battery 181 allows electrons to flow from the anode 120 to the cathode 140. In particular, the initial bias voltage caused by the current supplied from the battery initiates the removal of electrons from the anode and transfer of those electrons to the cathode, and also allows more dissolved oxygen to be produced because the removal of the electrons minimizes the reformation of water. Additional external electrical contacts can monitor voltage, current, and power or apply a particular external bias voltage to the photolytic cell.

The current regulator and resistor help control the flow of electrons from the anode to the cathode, thereby controlling the amount of dissolved oxygen formed and CO₂ fixed. The resistor creates a fixed control in the current flow, whereas the current regulator can be adjusted to increase or decrease the resistance of the current flow. Increasing the resistance of the current lowers the number of electrons flowing from the anode to the cathode, thereby lowering the overall production of dissolved oxygen and fixation of CO₂. Decreasing the resistance of the current increases the flow of electrons from the anode to the cathode, thereby increasing the amount of dissolved oxygen produced.

A battery may not be necessary. In particular, when the photolytic cell includes a p-n junction, it is expected based on known biased digital circuits that the p-n junction will produce a sufficient voltage such that the initial or continuous bias voltage from a battery is not needed.

8. p-n Junction

A p-n junction spontaneously provides a voltage to a circuit. In the present disclosure, this voltage is used to initiate the removal of electrons from the first light-activated catalyst to the anode current collector to the cathode and also allows more dissolved oxygen to be produced because the removal of electrons from the anode compartment minimizes the reformation of water. Similarly, more electrons and H⁺ ions are available for CO₂ fixation. A p-n junction is formed by joining p-type and n-type semiconductors in intimate contact at a junction. p-n junctions may be formed via ion implantation, diffusion of dopants, or epitaxy, i.e. growing a layer of crystal doped with one type of dopant on top of a layer of crystal doped with another type of dopant.

Bias voltage materials are normally prepared from Group III-Group V materials or doped Group IV materials. An n-type semiconductor is an extrinsic (i.e. doped) semiconductor in which the conduction electron density exceeds the hole density. In other words, the semiconductor includes dopant atoms which are capable of providing extra conduction electrons to a host material.

The semiconductor material of the n-type semiconductor may be As or P, used pure or doped into a Group IV material (e.g. Si, Ge, or Sn).

A p-type semiconductor is an extrinsic semiconductor in which the hole density exceeds the conduction electron density. In other words, the semiconductor is doped with dopant atoms in order to increase the number of positive free charge carriers.

The semiconductor material of the p-type semiconductor may be Al, Ga, or In, used pure or doped into a Group IV material (e.g. Si, Ge, or Sn).

In the absence of an externally applied voltage, e.g. from a battery, the p-n junction reaches an equilibrium condition in which a potential difference exists across the junction. The potential difference is known as the built-in potential.

The photolytic device may comprise a p-n junction on the anode side, on the cathode side, or on both the anode side and the cathode side. The most preferred case is where the bias voltage is applied at the anode side.

The built-in voltage may be greater than about 0.5 mV.

9. Light Source

The light source 107 provides the photon energy necessary to activate the first and/or second light-activated catalysts (i.e. photocatalysts). The light source can be from any known light source including, but not limited to, sunlight, UV light, laser light, incandescent light, light emitting diodes (LEDs) etc., depending on the activation requirement for the light-activated catalyst used. In particular embodiments, the light source may be external, i.e. from sunlight or from ambient lighting provided by other lights or lamps in a room. In other embodiments, the light source is an artificial light source, i.e. provided as a part of the photolytic apparatus.

The light source may provide a particular wavelength of light depending upon the catalyst used. When tungstate (WO₃) is used as a light-activated catalyst, the light source exposes visible light in order to activate WO₃. When TiO₂ or ZnO is used as a light activated catalyst, the light source used has a wavelength in the UV range, particularly in the range of 350 nm to 390 nm.

When the light source is artificial, it is preferably a narrow source of light spectrally matched to the photocatalyst for maximum efficiency and least heat generation. A laser light is the most preferred but not necessary. The wavelength of the laser light can be manipulated in order to attain a higher efficiency in exciting the light-activated catalyst and forming active oxygen. Also, laser light requires the photolytic cell to dissipate less overall heat. The laser light can be directed in a small area to energize the light-activated catalyst and avoid contact or irradiation with other components of the photolytic apparatus. A particularly preferred laser light that can be used to activate TiO₂ is an argon laser at 364 nm (400 mwatts/cm²), which has a total power of about 2 watts, although other UV sources, including an Hg arc lamp with a 365 nm line, are also available. The use of filters in combination with cooling or heat radiators make it practical to use most light sources so long as sufficient photon flux exists at the absorption wavelength of the photocatalyst.

Preferably, the light from the light source is evenly spread within the photolytic cell, to allow for maximal excitation of the light-activated catalyst. Along these lines, light from the light source can enter the photolytic cell through a transparent window from many positions, e.g. directly through the transparent window. Alternatively, light can enter the transparent window from a side, edge, back, bottom, or corner position and move through the transparent window by a waveguide to provide photon energy and excite the light-activated catalyst. Side entry of light into the transparent window of the photolytic cell should occur at a large angle, preferably at an angle of from about 70° to about 80°.

It may be desirable that the anolyte/catholyte itself is not exposed to the light. For example, blood can be the anolyte and preventing its irradiation is desirable. This can be achieved by, for example, ensuring that the light-activated catalyst is of sufficient thickness to absorb most or all of the light impinging within the photocatalyst

In some embodiments, the photolytic cell contains two different artificial light sources, one that illuminates only the first light-activated catalyst and one that illuminates only the second light-activated catalyst. In other embodiments, the first light-activated catalyst is activated in a first range of wavelengths, the second light-activated catalyst is activated in a second range of wavelengths different from the first range, and the photolytic cell contains two different artificial light sources or two slits from a common light source, one emitting at a wavelength in the first range and one emitting at a wavelength in the second range. These embodiments allow the two light-activated catalysts to be selectively activated as desired, providing a further degree of control

10. Pump

One or more pumps may be present to move anolyte/catholyte through the anode/cathode compartments. In this context, it is well known in the art how to obtain two or more flows of differing electrolyte compositions from a single pump. For longest pump replacement periods, magnetically levitated rotor pumps are most preferred.

11. Sensors Monitoring Reaction Chemistry

The photolytic apparatus can include one or more sensors that monitor the different chemical reactions occurring within the photolytic cell. The sensors can be used to measure for potential toxins and toxin levels. Various sensors and sensor systems can be used including visual observations of color changes of redox indicator dyes or gas bubble formation, closed electrical current measurements and pH measurements, and dissolved oxygen probe analysis. Ion and gas chromatography assays can also be performed and used to monitor O₂, H₂, and reduced CO₂-based carbon compounds. A dissolved oxygen probe can be used to test and monitor O₂ generation, as dissolved oxygen, in real time. Also, the photolytic apparatus can incorporate one or more portals to insert a dissolved oxygen probe, CO₂ probe, pH monitor, etc. in different locations if necessary. The photolytic apparatus can also incorporate separate sampling chambers to trap liquid and gas bubbles for testing. These sampling chambers could also incorporate a device, such as a septum for a hypodermic needle for instance, to obtain a sample for further testing. One skilled in the art would recognize numerous sensors could be used for monitoring the reaction chemistries occurring within the photolytic cell. This array of blood sample analyses is known as “blood gas”, “electrolyte”, or “blood chemical” analyses.

The photolytic device and photolytic cell can also include one or more process regulator devices that respond to the readings provided by the sensors. The process regulator devices increase or decrease the amount of dissolved oxygen or CO₂ output, the identity of the reduced CO₂ product formed, lower toxin levels, etc., depending on the requirements of the patient or of the photolytic cell. It is within the purview of one utilizing the photolytic artificial lung to determine what process regulator devices and specific products are required.

All of the seals in the photolytic apparatus are made of an inert material that properly seals fluids flowing through the photolytic apparatus from accidental contamination. The seals of the photolytic apparatus can also be formed of a biologically compatible non-interacting material, such as a silicone-based material.

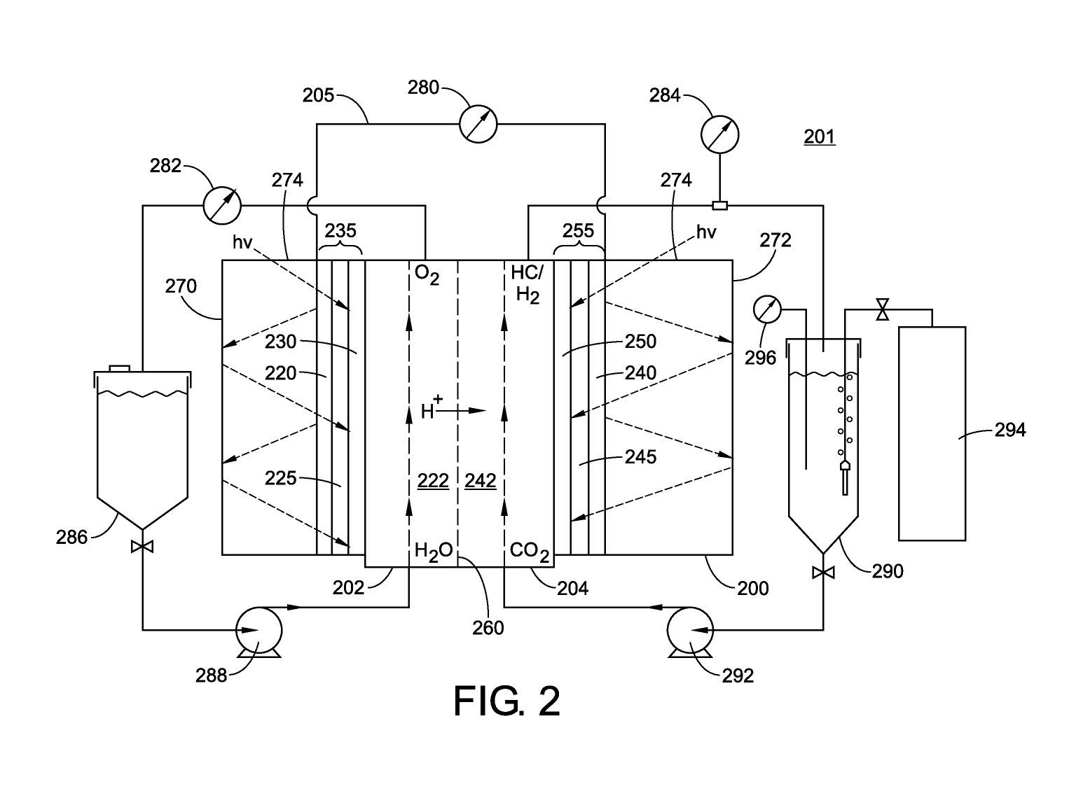

FIG. 2 shows another embodiment of a photolytic apparatus 201. The photolytic apparatus 201 includes a photolytic cell 200 having an anode compartment 202 and a cathode compartment 204, separated by a cation exchange membrane 260. The anode compartment contains an anode conductor layer 220 made from indium tin oxide (ITO), and disposed thereon an anode p-n junction 225 and disposed on the anode p-n junction 225 a first light-activated catalyst 230 which is made from TiO₂ anatase. In contrast to FIG. 1, the anode conductor layer 220, anode p-n junction 225, and first light-activated catalyst 230 here form a self-supporting photoanode 235. Similarly, the cathode conductor layer 240, cathode p-n junction 245, and second light-activated catalyst 250 here form a self-supporting photocathode 255. Put another way, the photoanode and photocathode are not coated upon a wall 270, 272 or substrate of the photolytic cell. Instead, the light here passes through a third wall 274. The other walls 270, 272 are coated with a reflective material that reflects the light (and its photon energy) back at the photoanode and photocathode.

An electrolyte reservoir 286 and a first pump 288 are shown for pumping cation-rich fluid through the anolyte flowpath 222 of the anode compartment and back into the reservoir 286. Similarly, an aqueous CO₂ reservoir 290 and a second pump 292 are shown for pumping CO₂-rich fluid through the catholyte flowpath 242 of the cathode compartment and back into the reservoir 290. Gaseous CO₂ is bubbled into the CO₂ reservoir 290 from tank 294 and measured by pH meter 296. An ammeter or voltmeter 280 is present along electrical circuit 205 to measure the current or voltage between the anode and the cathode. An O₂ detector 282 measures the output from the anode compartment, while a hydrocarbon detector 284 measures the production of hydrocarbons from the cathode compartment.

12. Optional Gas Sorption Device

Continual venting of carbon dioxide gas out of the photolytic cell can present different problems. In some embodiments, a CO₂ gas sorption device is used to minimize and provide control over the amount of CO₂ vented to the atmosphere. The gas sorption device captures CO₂ gas released from the oxygenated blood (or, in principle, any catholyte) in a concentrated form. The concentrated CO₂ can be processed or disposed of.

CO₂ can be captured using a number of different ways by a gas sorption device. The gas sorption device can use the process of chemi-absorption and convert CO₂ into a concentrated solid or solution form. The concentrate formed in the gas sorption device can then be disposed of as disposable cartridges having liquid or solid CO₂, or regenerated.

### Applications

### Photolytic Artificial Lung

In one application, the photolytic cell is incorporated into a photolytic artificial lung or respiratory assist device. This device is capable of facilitating gas exchange in the blood of a patient while bypassing the patient's diseased alveolar-capillary interface. In such an exchange, dissolved oxygen is already generated from water in the blood stream while carbon dioxide is removed and pH is controlled. The photolytic artificial lung oxygenates blood without the deleterious effect on red blood cells associated with direct gas sparging (i.e. blood cell lysis, pH balance difficulties, clotting, etc.). In particular, venous whole blood can first be circulated in the anode compartment of the photolytic cell as the anolyte. Following light exposure of the light-activated catalyst only (while not exposing the blood to the light), water (H₂O) in the blood is converted into H⁺ ions, electrons, and active oxygen. In whole blood, the H⁺ ions are immediately removed by reaction with bicarbonate ions to form carbonic acid. The carbonic acid then reacts with carbonic anhydrase in the blood to form water and carbon dioxide. The electrons are conducted away to the cathode compartment. The blood subsequently flows into the cathode compartment, where the CO₂ is removed while consuming the protons and electrons generated in the anode compartment. Alternatively, the CO₂ is merely released to the air by venting and only H₂ is generated at the cathode with the protons and electrons. Either way, releasing CO₂ from the blood returns the blood pH to physiologic target levels. The fraction of oxyhemoglobin in the blood rapidly increases, and the fraction of dissolved oxygen contained in the serum phase of the blood increases in a parallel manner with oxyhemoglobin as a result. Thus, the hemoglobin contained in whole blood is oxygenated with oxygen derived from the blood's own water content by only providing energy at mild conditions.

Preferably, the photolytic artificial lung comprises a blood inlet cannula, a pump, at least one photolytic cell, a light source that irradiates the photolytic cell(s), an oxygenated blood outlet cannula, and an optional carbon dioxide vent and/or absorption device. A power source and/or batteries can be present to power the pump or light source. One or more in-line sensors and processors can be present to monitor and optimize the blood flow through the system, the amount of oxygen and/or carbon dioxide generation, the presence of toxins, etc.

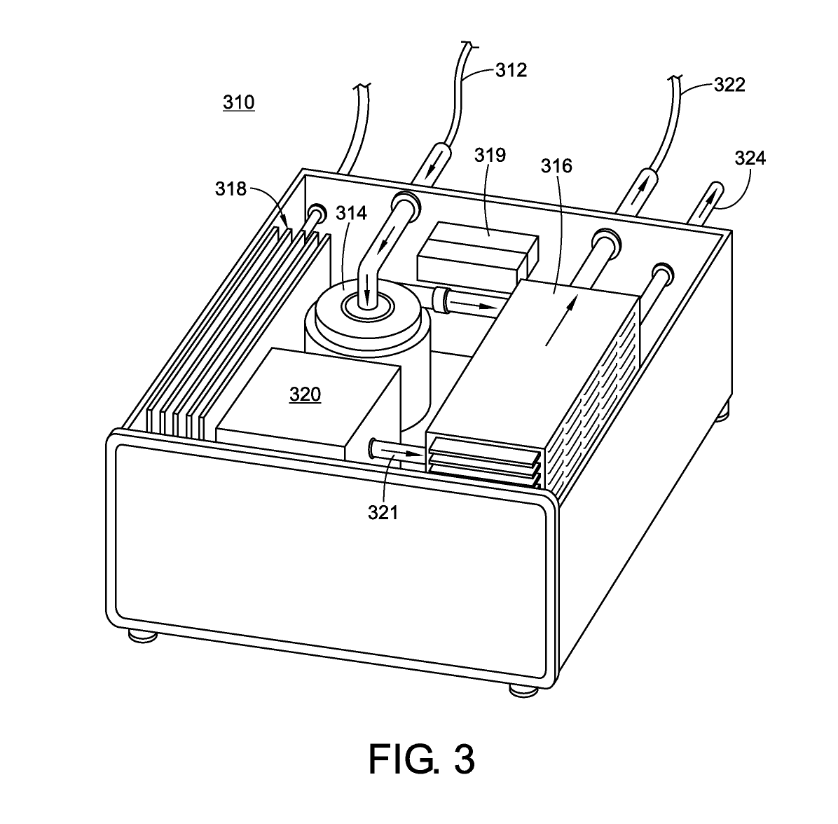

More particularly, FIG. 3 shows an embodiment of a device 310 that can be used as an extra-corporeal respiratory assist system. The device 310 includes a blood inlet 312 that cannulates blood from the patient. The blood inlet 312 is connected to a pump 314 that draws blood from the patient into the device 310. The pump 314 directs unsaturated blood through one or more photolytic cells 316. A power supply 318 or battery 319 activates the light source 320. The light source 320 emits photons 321 which irradiate the photolytic cells 316. In turn, the photolytic cells 316 photochemically initiate a series of chemical reactions that produce oxygen and remove carbon dioxide from the blood. Oxygenated blood travels from the artificial lung 310 back to the patient by way of a blood outlet 322. Carbon dioxide is removed from the device separately 324. Consequently, the artificial lung 310 takes blood from the venous circulation of a patient and returns it to the arterial circulation.

The device omits the gaseous state that causes problems which have limited other blood oxygenation technologies, while optionally releasing or consuming carbon dioxide. Also, the device does not require the careful control of temperature or pressure. As briefly mentioned above, the materials for use in the present photolytic device are generally biocompatible and prevent blood clogging or contamination. Blood contact with the coatings is also minimized. Diffusion layers, which can decrease oxygenation rates, are minimized using electrical conduction of electrons and cations to and from the photolytic site by incorporating thin films having good photolytic transparency, high conductivity through only one membrane, very high concentration gradients, and driven electrical and electrochemical conduction.

The wavelength, beam size, pulse duration, frequency and fluency of the light source can be adjusted to produce maximum and/or efficient gas exchange. Similarly, pump rate, flow-through capacity, etc. of the photolytic cells can also be adjusted. This can be accomplished by sensors and regulators which also monitor reaction chemistry, toxins, set point, etc. The sensors and regulators have the capacity to auto-regulate various parameters of the system in response to the conditions monitored by the sensors. Preferably, the photolytic artificial lung can provide at least 200 mL of dissolved oxygen per minute at 5 L/min of blood flow through the system; sufficient for most adults.

The photolytic device can be designed as an extra-corporeal device or an intra-corporeal device. For example, the photolytic artificial lung can be designed as a miniaturized, implantable unit. Such a unit can use a transcutaneous energy transmission system and/or an internal light source for energy conversion.

The following series of reactions occur in the anode compartment of the photolytic cell:

$$hv + 2 {H}_{2} O {\to }^{{TiO}_{2}} “ AO ” + 2 {H}^{+} + 2 {e}^{-}$$

$$AO {\to }^{{MnO}_{2}} 1 \text{/} 2 {O}_{2} + {H}_{2} O$$

$$2 {H}^{+} + 2 {HCO}_{3}^{-} \to 2 {H}_{2} {CO}_{3}$$

$$2 {H}_{2} {CO}_{3} {\to }^{CA cat .} 2 {H}_{2} O + 2 {CO}_{2}$$

$$2 {CO}_{2} \to 2 {CO}_{2 ( g )}$$

$$1 \text{/} 4 Hb + 1 \text{/} 2 {O}_{2} ≡ 1 \text{/} 2 Hb \text{:} {O}_{2}$$

The overall net anode reaction is as follows:

hν+¼Hb+2NaHCO₃→2CO₂(g)+H₂O+½Hb_{0.5}O₂+2e⁻+2Na⁺

The two electrons formed in the anode compartment are conducted away to the cathode via the anode conductor layer. The two Na⁺ ions pass through the cation exchange membrane into the catholyte in the cathode compartment.

When not processing blood, sodium hydroxide (NaOH) builds in the catholyte during the series of reactions in the photolytic cell. It is preferred that the NaOH is purged occasionally from the catholyte. If sodium chloride (NaCl) is used in the catholyte instead of NaOH, NaCl(s) may eventually form within the catholyte and would periodically be purged.

The reactions occurring in the cathode compartment of the photolytic cell are as follows:

2NaHCO₃→2Na⁺+2HCO₃⁻

2e⁻+2H₂O→H_{2(g)}+2OH⁻

2OH⁻+2HCO₃⁻→2CO^{3̅}+2H₂O

4Na⁺+2CO₃²⁻→2Na₂CO₃

The overall net cathode reaction is as follows:

2e⁻+2Na⁺+2NaHCO₃→H₂(g)+2Na₂CO₃

The Na₂CO₃ that is produced in the cathode compartment causes pH to rise. Based upon the overall anode and cathode reactions, the overall net photolytic cell reaction is:

hν+¼Hb+4NaHCO₃→H_{2(g)}+2Na₂CO₃+2CO_{2(g)}+H₂O+½Hb_{0.5}O

The CO₂ gas is released to atmosphere as is its current fate (or resorbed as low carbon number compounds in implanted versions). Some water forms in the blood, other water is consumed, and the Hb is converted to oxyhemoglobin. After the H₂ (g) is released as gas from the non-blood catholyte, the catholyte converts to soda ash which can be disposed of cheaply as non-hazardous waste.

### Oxygenation Device

In another application, the photolytic cell may be part of a photolytically driven electrochemical (PDEC) oxygenation and carbon dioxide removal apparatus. In the anode compartment, the apparatus utilizes the photolytic cell to convert light energy in order to simultaneously generate oxygen and electrical energy. The photolytic cell also removes carbon dioxide from the environment and converts it to a carbonate solid in the cathode compartment. Such an oxygenation apparatus may be useful, for example, in a spacecraft or submarine, or other vehicle or location that has a confined volume in which it is desirable to remove CO₂ and add O₂.

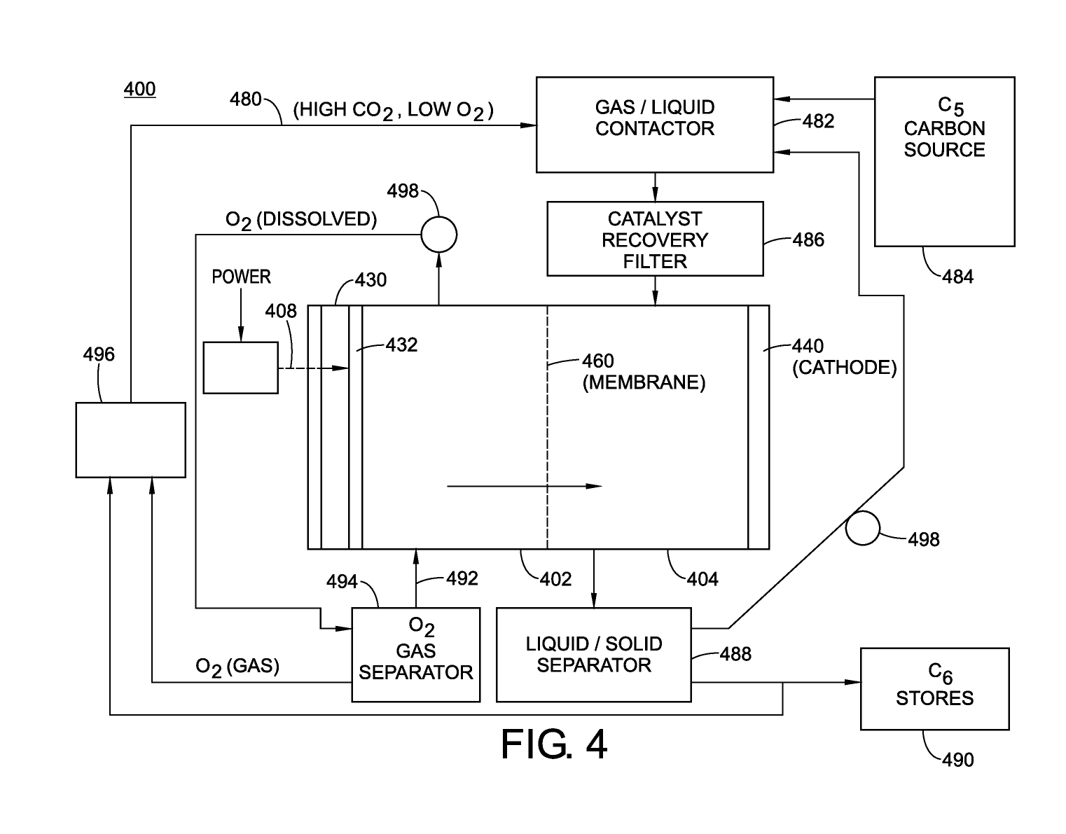

FIG. 4 is an exemplary schematic diagram for such an oxygenation apparatus. Here, oxygen is produced using water and photolytic energy and carbon dioxide is removed from stale air in the form of C₃ or C₆ compounds.

A PDEC cell 400 is used for the central reaction of producing oxygen in the anode compartment 402 and producing a C₆ compound, such as hexose sugar, from carbon dioxide in the cathode compartment 404.

In this regard, stale air (high in CO₂ and low in O₂) 480 is first contacted with a liquid in gas/liquid contactor 482 to convert the carbon dioxide into dissolved form in the liquid. The dissolved form is normally CO₂ (aq), but could also be HCO₃⁻, H₂CO₃ and/or CO₃²⁻. The liquid may be, for example, brine containing α-ketopentose containing a catalyst (typically of mixtures of Mg²⁺/PO₄³⁻ electrolyte) to convert carbon dioxide into dissolved form in the liquid. The liquid also contains O₆ pentose obtained from carbon source 484 which also contains a catalyst to form glycerate or the equivalent. For example, the catalyst may be a rubisco type enzymatic catalyst or a derivative compound. In this manner, the CO₂ and α-ketopentose are converted to two C₃ glycerate molecules in the liquid. The liquid may also be recycled catholyte. The gas/liquid contactor 482 can be a counter flowing percolating bed, a micro-porous membrane, gas sparger, etc. The gas/liquid contactor has a gas inlet, a liquid inlet, and an outlet.

The dissolved C₃ compounds may then be used as fuel cell fuel or food. Alternatively, it could be ultra-filtered to recover the catalyst in filter 486, and the filtrate is allowed to flow into the cathode compartment 404 of the PDEC cell 400. The catalyst can be recycled.

The dissolved carbon dioxide, catalyst, glycerate, and pentose and the liquid then flow into the cathode compartment 404. The glycerate is electrochemically reduced at the surface of the cathode 440. The surface of the cathode is preferably coated with a catalyst that facilitates a hydrogenation reduction reaction, such as Pb, Cd, Ni, Pd and the like. Hydrogen ions that migrate across the membrane 460 from the anode compartment 402 are used to form a hexose (C₆) sugar. The hexose sugar solution flows out of the cathode compartment 404 into a liquid/solid separator 488, where the liquid may be recycled and the hexose sugar placed in stores 490 or used as food for the crew, animals or microorganisms. For example the sugar-like compound, or carbohydrate-like compound, or glycerate can be recovered by crystallization, micro-filtration, electrodeionization, and the like.

The anode compartment 402 comprises the oxygen-producing portion of PDEC cell 400. Anolyte 492 such as NaCl brine, Na₂SO₄, K₂O₄, H₂SO₄, HCl, and the like flows into the anode compartment 402. The reaction of light 408 with the first light-activated catalyst 430 and disproportionation catalyst 432 causes the water present in the anolyte to form oxygen and hydrogen ions. As mentioned above, the hydrogen ions migrate into the cathode compartment 404 for further reaction. The oxygen flows out of the anode compartment 402 dissolved in the anolyte and optionally can be allowed to coalesce into O₂ bubbles. The dissolved oxygen and/or O₂ bubbles and brine flow to an oxygen gas separator 494 where gaseous oxygen is separated from the liquid anolyte. The anolyte is recycled to the anode compartment 402 while the oxygen flows to the enclosed volume 496 for breathing by humans, animals, microorganisms or other uses. The enclosed volume 496 may be considered a gas source for the gas/liquid contactor 482. The oxygen may also be pressurized for later use. The oxygen gas separator has an inlet, a gas outlet, and a liquid outlet. Pumps 498 are located as needed along the various lines.

Of course, modifications and differences will exist depending on the application. For example, the power source for this oxygenation apparatus may be a nuclear reactor, electrical generator, hydroelectric energy, solar energy, battery pack, fuel cell, and the like that is capable of providing energy for light production. As mentioned above, light may be from a laser, solar or other device capable of providing light at the appropriate wavelengths for the PDEC cell.

The present disclosure is further described with reference to the examples set forth below.

### Example

An ITO conducting layer was formed on a quartz substrate A TiO₂ photoanode layer was deposited on the ITO conducting layer.

The TiO₂ photocatalyst layer was constructed using a metal oxide precursor solution comprising titanyl nitrate, isopropanol, water, and glycine.

The metal oxide precursor solution was added to the ITO/substrate after passing through a 0.2 μm pore size syringe filter. A spin coater was used to produce a thin, uniform film. The film was then dried at 110° C. for 5 to 10 minutes to remove the solvent, and then was heated to 225° C. and held for 5 minutes to initiate combustion of the gel film to form the metal-oxide photocatalyst layer.

Oxygen production capability testing of the photoanode was then conducted using an enclosed Hansatech Cell with Oxygraph Model RS232 oxygen electrode. The enclosed cell was sealed to eliminate effects on the measurements from atmospheric oxygen.

The anolyte in this case was a Lockes-Ringer blood surrogate solution (sugar omitted) and the catholyte was a solution consisting of 2.3 wt % potassium iodide and 6.0 wt % I₂ in CO₃²⁻/HCO₃⁻ buffer. The cathode was a platinum wire and the TiO₂/ITO acted as the photoanode.

The photocatalyst was illuminated with 365 nm light to induce photocatalysis and oxygen level in the anolyte (as dissolved oxygen) was measured over time.

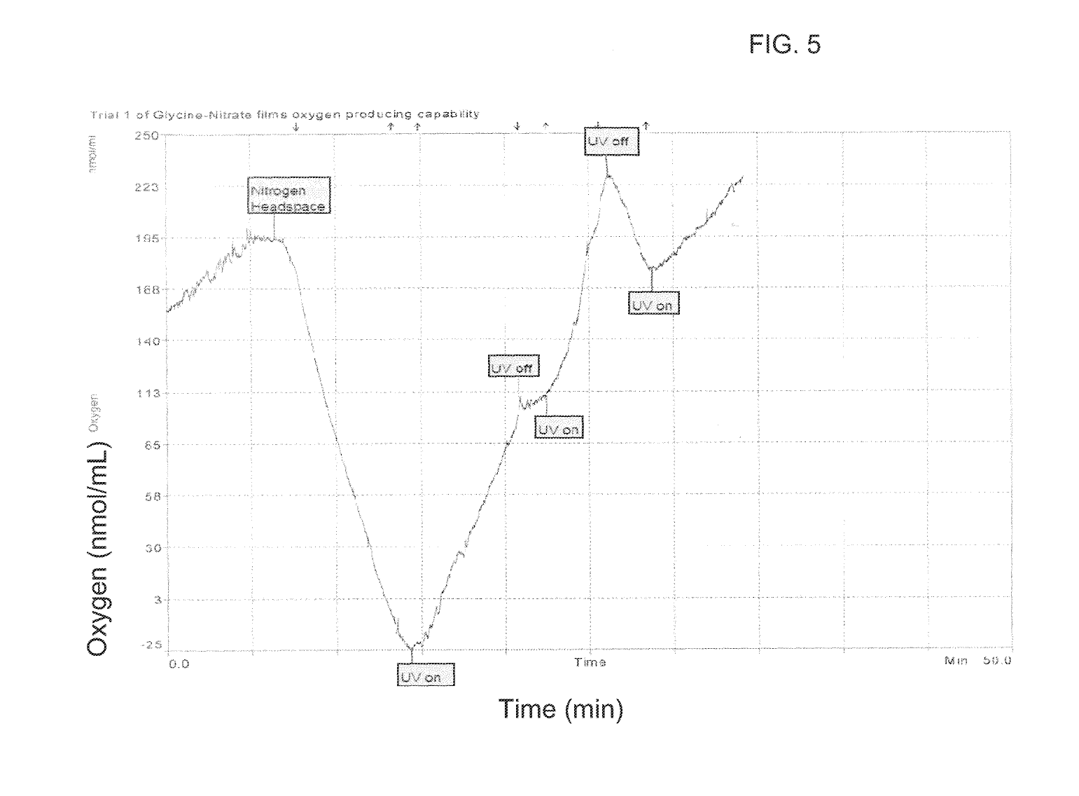

As FIG. 5 shows, oxygen production is a direct result of the activation of the photocatalyst by UV light. Without the UV light, oxygen concentration stabilized or decreased; with UV light, oxygen concentration increased. This phenomenon was observed through several on/off pulses of UV light and the pattern was repeatable many times for long periods without failing.

The processes, compositions, and photolytic cells of the present disclosure have been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A process for producing a metal oxide film on a substrate, the process comprising:
preparing a metal oxide precursor composition comprising a metal oxide precursor, an amino acid, and a solvent;
depositing the metal oxide precursor composition on a substrate to form a coating;
drying the coating to remove the solvent and form a gel film; and
heating the gel film to form the metal oxide film on the substrate.

2. The process of claim 1, wherein the metal oxide is TiO₂.

3. The process of claim 1, wherein the metal precursor is titanyl nitrate.

4. The process of claim 1, wherein the metal precursor is a blend of a non-nitrate-containing titanium compound and a nitrate-containing compound.

5. The process of claim 1, wherein the amino acid is glycine.

6. The process of claim 1, wherein the amino acid contains only atoms selected from the group consisting of carbon, oxygen, nitrogen, and hydrogen.

7. The process of claim 1, wherein the amino acid does not contain sulfur, phosphorus, chlorine, or selenium atoms.

8. The process of claim 1, wherein the solvent is water.

9. The process of claim 1, wherein the metal oxide precursor composition further comprises an alcohol.

10. The process of claim 9, wherein the alcohol is isopropyl alcohol.

11. The process of claim 1, wherein the metal oxide precursor composition is deposited by spin coating.

12. The process of claim 1, further comprising etching the substrate with an acid prior to depositing the metal oxide precursor composition on the substrate.

13. The process of claim 12, wherein the acid is HCl or HF.

14. The process of claim 1, wherein the coating is dried at a temperature of 0° C. to 150° C.

15. The process of claim 1, wherein the coating is dried for a time period of from 1 second to 59 minutes.

16. The process of claim 1, wherein the gel film is heated to a temperature of from 200° C. to 250° C.

17. The process of claim 1, wherein the gel film is heated for a time period of 3 minutes to 59 minutes.

18. The process of claim 1, wherein, in the metal oxide precursor composition, a molar ratio of the metal precursor to the amino acid is from about 9:10 to about 5:1.

19. A process for producing a TiO₂ film on an indium tin oxide (ITO) surface, the process comprising:
providing a titanium oxide precursor solution comprising a titanyl nitrate, glycine, water, and isopropyl alcohol;
depositing the titanium oxide precursor solution on the indium tin oxide surface to form a coating;
drying the coating to form a gel film; and
heating the gel film to form the TiO₂ film on the indium tin oxide surface.

20. An electronic device comprising a metal oxide film produced by the process of claim 1.

21. A continuous process for producing a multilayered metal oxide film on a substrate, the process comprising:
preparing a metal oxide precursor solution comprising a metal oxide precursor, an amino acid, and a solvent;
depositing the metal oxide precursor solution on a substrate to form a coating;
drying the coating to remove the solvent and form a gel film;
heating the gel film to form a metal oxide film layer on the substrate; and
repeating the depositing, drying, and heating steps multiple times in succession until the desired multilayered metal oxide film is obtained.

22. The process of claim 21, wherein a different metal oxide precursor solution is prepared during repeating of the depositing, drying, and heating steps, so that the multilayered metal oxide film contains different metals in at least two adjacent layers.

23. A continuous process for producing a multilayered TiO₂ film on an indium tin oxide (ITO) surface, the process comprising:
providing a titanium precursor solution comprising a titanyl nitrate, glycine, water, and isopropyl alcohol;
depositing the titanium precursor solution on the indium tin oxide surface to form a coating;
drying the coating to form a gel film;
heating the gel film to form the TiO₂ film on the indium tin oxide surface; and
repeating the depositing, coating, drying, and heating steps multiple times in succession until the desired multilayered TiO₂ film is obtained.
